(19) United States
(12) Patent Application Publication
(10) Pub. No.: US 2008/0114935 A1
(43) Pub. Date: May 15, 2008

(54) Memory Card System and Method Transmitting Host Identification Information Thereof

(76) Inventor: KWANG-IL JEONG, Yeosu-si (KR)

Correspondence Address: F. CHAU & ASSOCIATES, LLC, 130 WOODBURY ROAD, WOODBURY, NY, 11797, US

(21) Appl. No.: 11/938,575

(22) Filed: Nov. 12, 2007

(30) Foreign Application Priority Data
Nov. 13, 2006 (KR) 10-2006-0111794

(51) Int. Cl. G06F 12/00

(52) U.S. Cl. 711/115; 711/E12.001

(57) ABSTRACT

Disclosed is a memory card system and method for transferring host identification information. The memory card system includes a host generating a command to transfer host identification information, and a memory card generating a response signal in response to a command. The memory card receives the host identification information from the host and conducts an operation customized to the host. In the memory card system, since the memory card accepts host identification information from the host, it is possible to conduct an operation customized to a specific type or version of the host. Moreover, the memory card is able to execute an operation in correspondence with the host linking thereto.

### CROSS-REFERENCE TO RELATED APPLICATION

This application claims priority under 35 U.S.C. §119 to Korean Patent Application No. 10-2006-0111794 filed on Nov. 13, 2006, the entire contents of which are hereby incorporated by reference.

### BACKGROUND OF THE INVENTION

The present invention relates to memory card systems and more particularly, to a memory card system and a method for transmitting host identification information of the memory card system.

Memory cards, such as Secure Digital (SD) cards, Multi Media Cards (MMCs), eXtreme Digital (xD) cards, Compact Flash (CF) cards, Smart Media (SM) cards, memory sticks, and so forth, are widely used. Memory cards such as these are used in various kinds of hosts such as mobile phones, MP3 players, portable media players (PMPs), digital cameras, and so on.

FIG. 1 is a block diagram of a general memory card system. Referring to FIG. 1, the memory card system 1 includes a host 10 and a memory card 20. The host 10 includes a host controller 11 and a host connection unit 12. The memory card 20 includes a card connection unit 21, a card controller 22, and a memory 23.

The host connection unit 12 and the card connection unit 21 each have pluralities of pins. These pins include a command pin, data pins, a clock pin, power pins, and so on. The number of pins varies according to the type of memory card 20. As an example, an SD card has nine pins.

The host 10 writes data into the memory card 20 or reads data from the memory card 20. The host controller 11 transfers a command (e.g., a writing command), a clock signal CLK generated from a clock generator (not shown) of the host 10, and data DAT to the memory card 20 by way of the host connection unit 12. The card controller 22 stores data into the memory 23 in response to the writing command received through the card connection unit 21. A clock signal provided by a clock generator (not shown) of the card controller 22 provides the timing for the writing of data into the memory 23.

The memory card 20 shown in FIG. 1 is operable in connection with various types of hosts 10. For example, the memory card 20 is usable in connection with a mobile phone, an MP3 player, a PMP, or a digital camera. The memory card 20 performs an operation requested by the host 10 without regard to the identification or type of the host 10.

The manner in which the memory card 20 is utilized may depend on the host. Even hosts of the same kind, for example, two distinct digital cameras, may utilize the memory card 20 differently. However, the memory card 20 operates in accordance with instructions received from the host 10, without regard to information about the host 10. Accordingly, a conventional memory card cannot perform an operation specific to a particular type of host.

Some memory cards, such as an SD card or MMC, conduct an initializing operation. During the initialization operation, the host is able to receive a variety of information about the memory card. However, the memory card is unable to receive information about the host. For example, the memory card cannot receive information pertaining to the host such as a manufacturer, a model name, etc.

### SUMMARY OF THE INVENTION

Exemplary embodiments of the present invention relate to a memory card system including a host transferring a command including host identification information. A memory card receives the command and transfers a response signal in response to the command.

A method of transferring host identification information in a memory card includes generating a command, from a host, to transfer the host identification information. A response signal is generated from a memory card in response to the command.

A memory card system includes a host transferring a command including host identification information to a memory card. The memory card receives the command and transfers a response signal to the host in response to the command. After receiving the command including the host identification information, the memory card performs an operation customized for the host based on the identification information.

### BRIEF DESCRIPTION OF THE FIGURES

Non-limiting and non-exhaustive exemplary embodiments of the present invention will be described with reference to the following figures, wherein like reference numerals may refer to like parts throughout the various figures. In the figures:

FIG. 1 is a block diagram of a general memory card system;

FIG. 2 is an external diagram of a SD card;

FIG. 3 shows an assignment of pin names and descriptions of the SD card shown in FIG. 2;

FIGS. 4A and 4B show formats of command and response signal defined in FIG.3;

FIGS. 5A through 5C illustrate a pattern of transferring host identification information in a memory card system according to an exemplary embodiment of the present invention;

FIGS. 6A and 6B illustrate a pattern of transferring host identification information in a memory card system according to an exemplary embodiment of the present invention; and

FIG. 7 is a flow chart showing a procedure of transferring host identification information in the memory card system in accordance with an exemplary embodiment of the present invention.

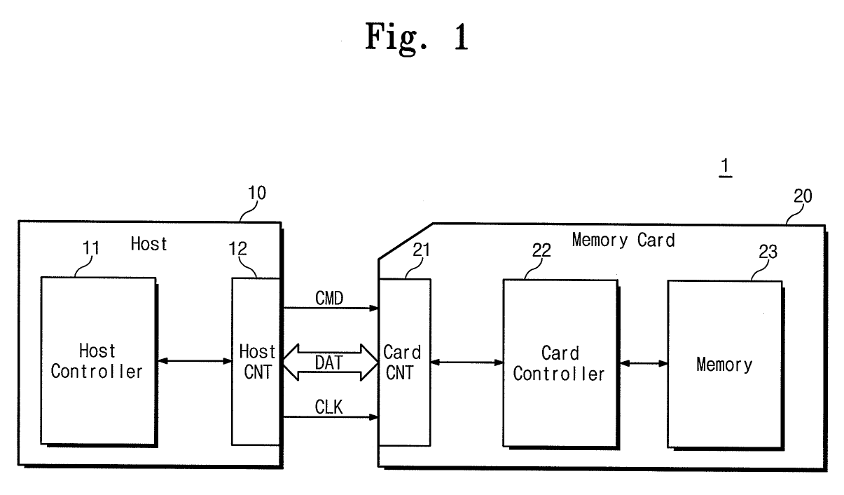

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the embodiments set forth herein. Like reference numerals may refer to like elements throughout the accompanying figures.

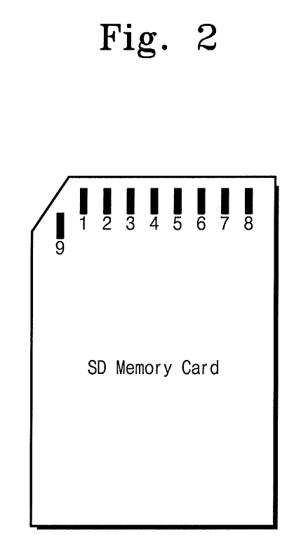

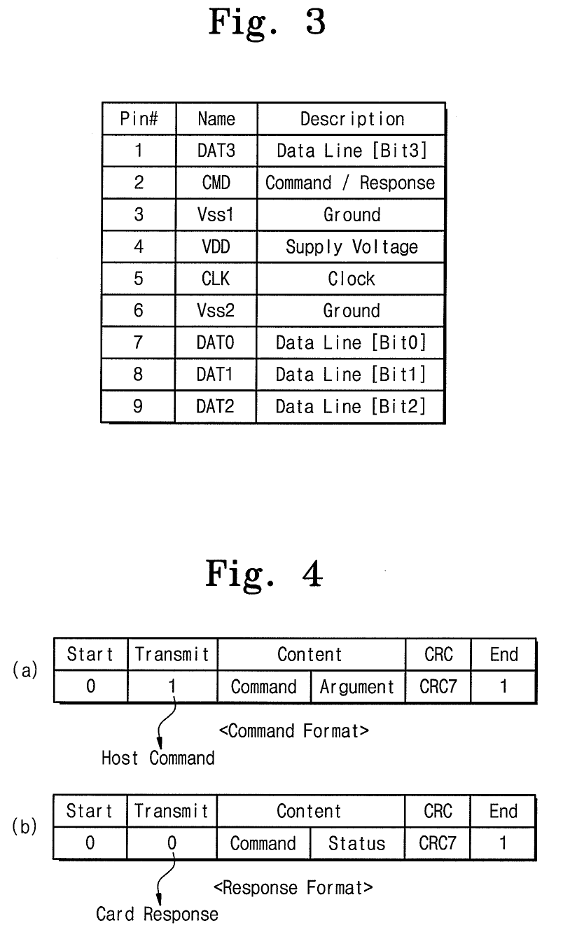

FIG. 2 shows an external configuration of a Secure Digital (SD) card, and FIG. 3 shows an assignment of pin names and descriptions of the SD card shown in FIG. 2. Referring to FIG. 2, the SD card includes nine pins. As shown in FIG. 3, the SD card includes four data pins (pin numbers are 1, 7, 8, and 9), a single command pin (pin number is 2), a single clock pin (pin number is 5), and three power pins (pin numbers are 3, 4, and 6).

The command pin 2 transfers a command and a response signal between the memory card and a host. The command is transferred to the memory card from the host. The response signal is transferred to the host from the memory card. Formats of the command and response signal will be detailed below with reference to FIGS. 4A and 4B.

FIGS. 4A and 4B show formats of command and response signals defined in FIG. 3. FIG. 4A shows a format of the command and FIG. 4B shows a format of the response signal.

Referring to FIG. 4A, the command format includes a start bit, a transmission bit, content, a cyclic redundancy check (CRC) code, and an end bit. Here, it is assumed that the command is composed of 48 bits.

The command format normally begins with the start bit. Here, the start bit is normally defined as ‘0’. The transmission bit is provided to define a direction of transmission. If the transmission bit is ‘1’, data is transferred to the memory card from the host. If the transmission bit is ‘0’, data is transferred to the host from the memory card.

The content is composed of a command and an argument. The command is formed of 6 bits. This 6-bit command may be decoded into one of 64 commands. The content includes an argument (e.g., an address). The argument is formed, for example, of 32 bits. All of the commands are protected by the CRC code. The CRC code is formed of, for example, 7 bits. The end bit is provided to terminate command transmission. The end bit is normally defined in ‘1’.

Referring to FIG. 4B, the response signal includes a start bit, a transmission bit, content, a CRC code, and an end bit. As shown in FIGS. 4A and 4B, the response signal format may be in-part similar to the command format.

The response signal format normally begins with a start bit of ‘0’ preceding the transmission bit of ‘0’. The content is formed of a command and a status signal. The command is formed of 6 bits and the status signal is formed of 32 bits. The status signal is provided to inform the host of a current state of the memory card.

As aforementioned, a command is transferred to the memory card from the host, a response signal is transferred to the host from the memory card, and data is exchanged between the host and the memory card. A memory card such as an MMC or SD card is initialized in an identification mode. During the initialization, the host obtains memory card identification information such as capacity, manufacturer, and serial number of the memory card.

The memory card system according to an exemplary embodiment of the present invention, during or after the initialization, executes a procedure for transferring host identification information to the memory card. The memory card, having received the host identification information, may then tailor operation to the needs of the specific type of host.

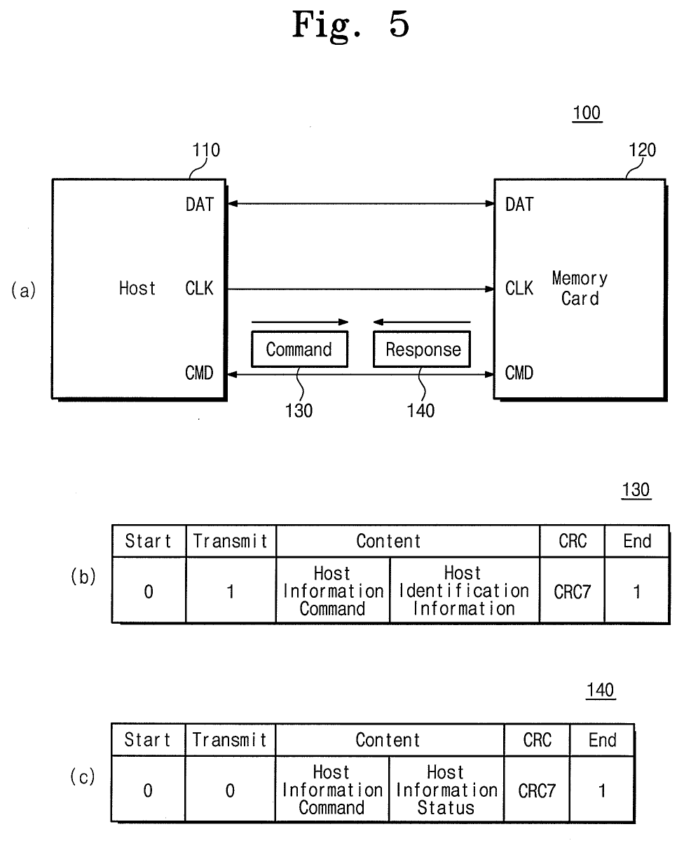

FIGS. 5A through 5C illustrate a pattern of transferring host identification information in a memory card system according to an exemplary embodiment of the present invention. Referring to FIG. 5A, the memory card system 100 includes a host 110 and a memory card 120. The host 110 and the memory card 120 are electrically connected to each other by way of a data line, a clock line, and a command line.

The host 110 transfers a specific command 130 to the memory card 120 through the command line for transmission of host identification information. Referring to FIG. 5B, the specific command 130 includes a host information command. Here, the host information command is provided to transfer host identification information to the memory card 120. The host information command is a command newly defined herein. The host 110 transfers the host identification information through the specific command 130.

The memory card 120 includes a nonvolatile memory (not shown) and a memory controller (not shown). The nonvolatile memory is made of a NAND or NOR flash memory. The memory controller operates to control an overall function such as writing and reading operations of the nonvolatile memory.

The memory card 120 transfers a specific response signal 140 to the host 110 in response to the host information command provided from the host 130. Referring to FIG. 5C, the specific response signal 140 includes the same host information command as the specific command 130. The specific response signal 140 also includes a host information status signal. Here, the host information status signal is provided to inform the host 110 that the memory card 120 responded to the host information command 130.

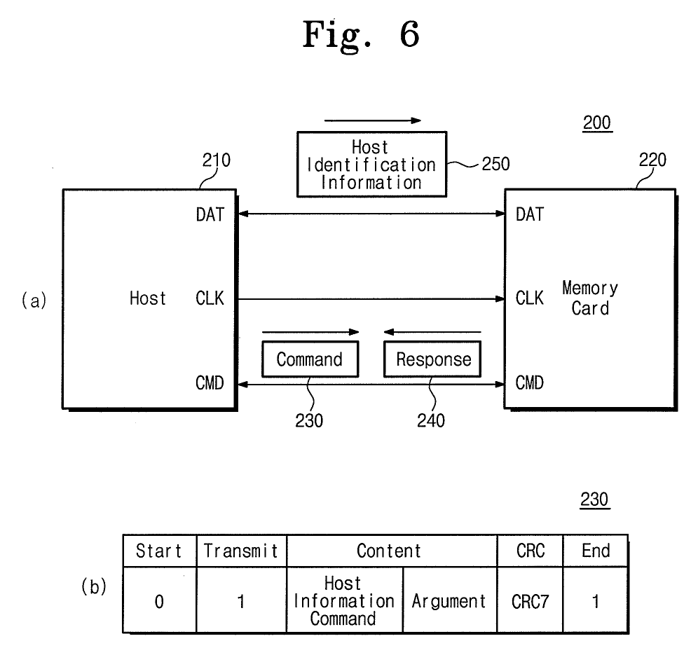

FIGS. 6A and 6B illustrate a pattern of transferring host identification information in a memory card system according to an exemplary embodiment of the present invention. Referring to FIG. 6A, the memory card system 200 includes a host 210 and a memory card 220. The host 210 and the memory card 220 are electrically connected to each other by way of a data line, a clock line, and a command line. The host 210 may transfer a password confirmation command 230 to the memory card 220 and the memory card 220 may return a password confirmation response 240 to the host 210 in a manner similar to the way the host information command 130 and response 140 are transferred as described above with respect to FIG. 5.

In the memory card system shown in FIG. 6, the argument has a predetermined bit number (e.g., 32 bits). If the host identification information is over 32 bits, the host identification information may be transferred in multiple steps. In this case, the memory card system 200 according to an exemplary embodiment of the present invention is able to transfer the host identification information to the memory card 220 by way of the data line.

The host 210 transfers the specific command 230 to the memory card through the command line for transmission of the host identification information. As shown in FIG. 6B, the specific command 230 includes a host identification command. In the memory card system 200 shown in FIG. 6, the host 210 transfers the host identification information by way of the data line. Here, for security of the host identification information, a password or a cryptographic algorithm may be used.

The memory card system according to an exemplary embodiment of the present invention performs a procedure for transferring host identification information during or after initialization. The host identification information is transferred over the command or data line. After the memory card receives the host identification information, the memory card is able to customize an operation to a specific type of the host.

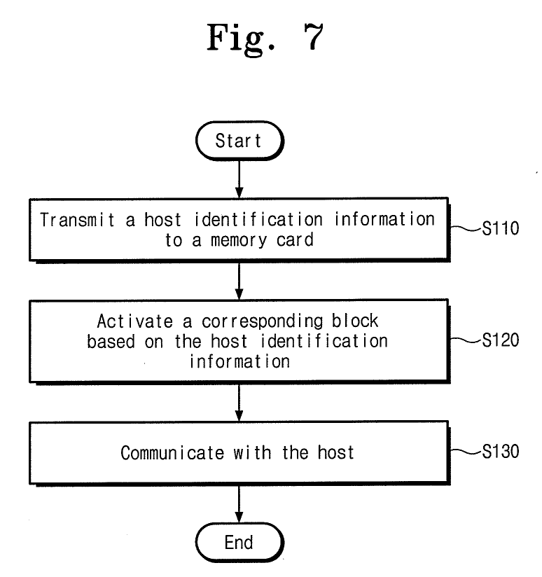

FIG. 7 is a flow chart showing a procedure of transferring host identification information in the memory card system in accordance with an exemplary embodiment of the present invention. Referring to FIG. 7 in conjunction with FIGS. 5 and 6, the procedure of transferring host identification information in the memory card system is described.

First, in a step S110, the host 110 or 210 transfers host identification information to the memory card 120 or 220. During this step, the host identification information is transferred through the command line as shown in FIG. 5, or through the data line as shown in FIG. 6. In the case of transferring the host identification information through the command line, the host identification information is included in the argument of the command format 130.

Next, in a step S120, the memory card 120 or 220 activates a corresponding specific block with reference to the received host identification information. Here, the specific block is set to operate for a specific type of the host 110 or 210.

Then, in a step S130, the memory card 120 or 220 communicates with a specific type of the host 110 or 210 by means of the activated specific block.

As described above, in the memory card system according to an exemplary embodiment of the present invention, since the memory card accepts host identification information from the host, it is possible to conduct an operation designed for a specific type or version of the host. Moreover, the memory card is able to execute an operation in correspondence with the host linking thereto.

The above-disclosed subject matter is to be considered illustrative, and not restrictive.

What is claimed is:

1. A memory card system comprising:
a host transferring a command including host identification information; and
a memory card receiving the command and transferring a response signal in response to the command.

2. The memory card system as set forth in claim 1, wherein after receiving the command including the host identification information, the memory card performs an operation based on the host identification information.

3. The memory card system as set forth in claim 2, wherein the operation based on the host identification information performed by the memory card includes activating a block, within the memory card, corresponding to the host identification information.

4. The memory card system as set forth in claim 1, wherein the memory card is an SD card.

5. The memory card system as set forth in claim 1, wherein the memory card is an MMC.

6. The memory card system as set forth in claim 1, wherein the host transfers the command including the host identification information to the memory card by way of a command line.

7. The memory card system as set forth in claim 6, wherein the host identification information is in a command format.

8. The memory card system as set forth in claim 7, wherein the host identification information is included in an argument of the command format.

9. The memory card system as set forth in claim 1, wherein the host transfers the command including the host identification information to the memory card by way of a data line.

10. The memory card system as set forth in claim 1, wherein the memory card comprises:
a nonvolatile memory; and
a memory controller controlling the nonvolatile memory.

11. The memory card system as set forth in claim 10, wherein the nonvolatile memory is a NAND flash memory.

12. The memory card system as set forth in claim 10, wherein the nonvolatile memory is a NOR flash memory.

13. A method of transferring host identification information in a memory card system, comprising:
generating a command, from a host, to transfer the host identification information; and
generating a response signal, from a memory card, in response to the command.

14. The method as set forth in claim 13, wherein the memory card receives the command and thereafter performs an operation based on the host identification information.

15. The method as set forth in claim 14, wherein the operation based on the host identification information performed by the memory card includes activating a block, within the memory card, corresponding to the host identification information.

16. The method as set forth in claim 13, wherein the memory card is an SD card.

17. The memory card system as set forth in claim 13, wherein the memory card is an MMC.

18. The method as set forth in claim 13, wherein the host transfers the host identification information to the memory card by way of a command line.

19. The method as set forth in claim 13, wherein the host identification is in a command format.

20. The method as set forth in claim 13, wherein the host identification information is included in an argument of the command format.

21. The method as set forth in claim 13, wherein the host transfers the host identification information to the memory card by way of a data line.

22. A memory card system comprising:
a host transferring a command including host identification information for identifying a host to a memory card, the memory card receiving the command and transferring a response signal to the host in response to the command, wherein after receiving the command including the host identification information, the memory card performs an operation customized for the host based on the identification information.
